(19) United States
(12) Patent Application Publication
(10) Pub. No.: US 2026/0348515 A1
(43) Pub. Date: Nov. 5, 2026

(54) IMPLEMENT HOLDER

(71) Applicant: ELFA INTERNATIONAL AB, VÄSTERVIK (SE)

(72) Inventors: Peter NILSSON, VÄSTERVIK (SE); Lars RYDÉN, VÄSTERVIK (SE)

(21) Appl. No.: 19/487,991

(22) PCT Filed: May 21, 2024
(86) PCT No.: PCT/SE2024/050492

§ 371 Date: Nov. 25, 2025

(30) Foreign Application Priority Data
May 26, 2023 (SE) 2350646-2

(51) Int. Cl. F16M 13/02; F16B 45/00

(52) U.S. Cl. CPC F16M 13/022; F16B 45/00

(57) ABSTRACT

The disclosure relates to an implement holder (1) adapted for attachment to a suspension bar (3), wherein the suspension bar (3) comprises a rail (5) comprising a rear surface (4) configured to be arranged horizontally on a vertical surface, such as a wall or similar, a lower flange (7) and an upper flange (9), each flange (7, 9) having portions that are directed obliquely upwards when the rail (5) is attached to the vertical surface. The implement holder (1) comprises a holding element (11) for suspending an implement, such as a tool, a piece of garden or sport equipment or another object, and a fastening device (13) which enables the holding element (11) to be releasably attached to the suspension bar (3). The fastening device (13) comprises an interface (15), comprising a suspension slot (23) and a mounting slot (25) for retaining engagement with the lower flange (7) and the upper flange (9) of the suspension bar (3), and a locking device (17) comprising a latch element 27 configured to be moved between a locked mode (LM) and an opened mode (OM. The latch element (27) secures the lower flange (7) of the suspension bar (3) in the suspension slot (23) when in locked mode (LM).

### FIELD OF THE INVENTION

The present invention relates to an implement holder adapted for attachment to a suspension bar.

### BACKGROUND

The invention relates to a system for suspending various objects from the walls of a storge space, for example a garage. One or several suspension bars are attached to the wall(s) of the storage space in a horizontal orientation and objects such as tools, implements, sports and leisure equipment, garden equipment and power cords are suspended from the walls by means of hooks or other suspension devices to get an overview of the items and to interfere with the floor space as little as possible. Alternatively, the suspension bars may be releasably attached to vertically oriented columns or hang standards.

EP 3 206 840 shows an example of such a suspension system. The system comprises a suspension bar consisting of a web and two arc-shaped flanges that extend away from the web. Holder element(s) comprising a resilient gripping section and two stiff pivoting arms can be attached to the suspension bar by hooking a part of the pivoting arms onto the upper flange and lower flange of the suspension bar. The resilient gripping portion can be moved between different position and an object can be clamped between the stiff pivoting arms. This suspension system is not adapted to clamp and hold large and/or heavy objects.

### SUMMARY

The object of the invention is to provide an implement holder having holding elements of any optional type for suspending various objects, including heavy and large objects.

A further object is to provide an implement holder which is fixedly attached to a suspension bar in a safe manner.

To this end, there is provided an implement holder adapted for attachment to a suspension bar, wherein the suspension bar comprises a rail comprising a rear surface configured to be arranged horizontally on a vertical surface, such as a wall or similar, a lower flange and an upper flange, each flange having portions directed obliquely upwards when the rail is arranged to the vertical surface, wherein the implement holder comprises a holding element for suspending an implement, such as a tool, a piece of garden or sport equipment or another object, and a fastening device which enables the holding element to be releasably attached to the suspension bar, wherein the fastening device comprises an interface comprising a suspension slot and a mounting slot for retaining engagement with lower flange and the upper flange of the suspension bar, and a locking device, comprising a latch element configured to be moved between a locked mode and an opened mode, wherein the latch element is adapted to secure the lower flange of the suspension bar in the suspension slot when in locked mode.

Since both the upper and the lower flange of the suspension bar have portions that are angled directed obliquely upwards and the fastening device comprises an interface comprising a suspension slot and a mounting slot for retaining engagement with the profile of the suspension bar, the flanges can both contribute to carrying the load of the holding element and when an object is suspended from the holding element, the weight it will exert on the holding element. The locking element helps keeping the fastening device from displacement in the suspension bar caused by a torque as a result from the weight suspended in the holding element. Instead of a locking device the fastening device may be releasably secured to the suspension bar in other ways, for example in a form-fitting manner.

In one embodiment, the lower flange may be bent out of a plane of the rear surface of the rail and the upper flange may extend upwardly from the plane of the rear surface. The lower flange may be bent out of the plane more than 90 degrees in an angle that correspond to the angle of the suspension slot in the fastening device. Thereby the rail becomes capable of suspending the fastening device. The upper flange may be bent in the direction towards the fastening device. At least partially, the upper and the lower flange may extend in slightly different directions.

In one embodiment, the upper flange may comprise an inner and an outer portion that are differently angled with respect to the plane of the rear surface. This contributes to prevent the implement holder from swinging in the plan of the vertical surface. Especially if the upper flange is provided with a portion that projects more or less horizontal from the plane of the rear surface.

Preferably, the latch element may abut against a bend in the lower flange when in locked mode. This serves to lock the fastening device to the suspension bar even more reliably. The bend may be formed when the lower end of the rail is bent or of the plane to form the lower flange.

In one embodiment, the latch element may abut against a front face of the rail, when in opened mode. The front face of the rail is opposite to the rear surface of the rail. Only a portion of the latch element can abut against the front face in the opened mode, while most of the latch element will abut against the front face in the locked mode. The latch element may be arranged in a cavity formed between the mounting slot and the suspension slot.

Preferably, the fastening device may have a front face and a rear face, and the rear face is facing the front face of the rail when the implement holder is attached.

Thus, the interface and the latch device may be arranged in the rear face of the of the fastening device and the holding element may extend from the front face of the fastening device.

Preferably, the locking element may be rotatably attached to a twist actuator. The twist actuator may be arranged on the front face of the fastening device configured to be moved between two predetermined positions, to move the latch element between the locked mode and the opened mode. The twist actuator may have different shapes but should be easy to manoeuvre with one hand. It may be connected to the locking element via a shaft that is arranged between the front face and the rear face of the fastening device. The twist actuator the locking element may be connected to each other through a clamping engagement. The parts are thus easy to separate and replace. The fastening device, twist actuator, and the latch element are preferably made of a plastic material providing the parts resilient properties and can be manufactured through injection moulding. Typically, PA6 (polyamide) with a 30% glass fiber content may be considered a useful choice.

In one embodiment, the predetermined positions may be spaced 90° apart. The twist actuator can be turned in a range between stoppers arranged on the front face of the fastening device. Both the stoppers and the twist actuator may be arranged in a recess on the front face of the fastening device to prevent interfering with an object suspended in the implement holder. The recess may have the shape of an ellipse or a circle. The stoppers may be tabs arranged in the recess, 90 degrees apart.

In one embodiment, the holding element may be arranged at a lower end of the fastening device, separate from the twist actuator. The holding element is preferably arranged below the twist actuator along the transverse extension direction of the fastening element to prevent interfering with an object suspended in the implement holder.

Preferably, the holding element may be provided with at least one leg, releasably connected to the fastening device by a clamping engagement. Depending on the size and weight of the object that are suspended in the implement holder, the holding element can be provided with one or two legs. A first end of the leg may extend from the front face of the fastening device and the second end of the leg may extend through the fastening device to the rear face of the fastening device. The second end may be attached to the fastening device by clamping engagement by using a spring washer, but other solutions are possible. Thus, the holding element can easily be replaced.

In one embodiment, the holding element may have a hook-like appearance. Whereby a first end of the leg is slightly bent upwards to prevent suspended object from sliding off. The length of each leg depends on the size of the suspended object. Preferably between 5 and 15 cm. Most preferably between 7 and 12 cm. The legs may be made of metal and can partly be lined with a dampening friction material such as rubber to reduce the risk that an object suspended in the implement holder slides along the legs.

In one embodiment, the fastening device may be provided with at least one fixation hole for fixation of the implement holder at the vertical surface. The fixation hole may be arranged between the front face and the rear face of the fastening device. The fastening device may thus be secured around the suspension bar and prevents the fastening device from being moved sideways along the rail if a screw is inserted in the through hole. The fastening device may also be attached to a wall directly without any suspension bar by using these fixation holes. Each hole should be positioned so that it does not interfere with the interface at the rear face of the fastening device.

It is noted that embodiments of the invention may be embodied by all possible combinations of features recited in the claims.

### BRIEF DESCRIPTION OF THE DRAWINGS

The above, as well as additional objects, features, and advantages of the present invention, will be better understood through the following illustrative and non-limiting detailed description of preferred embodiments of the present invention, with reference to the appended drawings, where the same reference numerals will be used for similar elements, wherein:

FIG. 1A illustrates a front view of the implement holder according to a first embodiment of the invention in a locked mode.

FIG. 1B illustrates a side view of the implement holder in FIG. 1A.

FIG. 1C illustrates a perspective side view of the implement holder according to FIG. 1A attached to a suspension bar.

FIG. 1D illustrates a perspective front view of the implement holder according to FIG. 1A attached to a suspension bar.

FIGS. 2A-2D illustrates the same views as FIGS. 1A-1D with the implement holder in an open mode.

FIGS. 3A-3D illustrates a second embodiment of the implement holder in the same views as FIGS. 1A-1D.

FIG. 4A illustrates how the parts of the implement holder in FIG. 1A are attached to each other.

FIG. 4B illustrates how the parts of the implement holder in FIG. 3A are attached to each other.

FIG. 5A illustrates a rear view of the implement holder in FIG. 1A.

FIG. 5B illustrates a rear view of the implement holder in FIG. 3A.

All the figures are schematic, not necessarily to scale, and generally only show parts which are necessary to elucidate the embodiments, wherein other parts may be omitted.

### DETAILED DESCRIPTION OF THE EXEMPLARY EMBODIMENTS

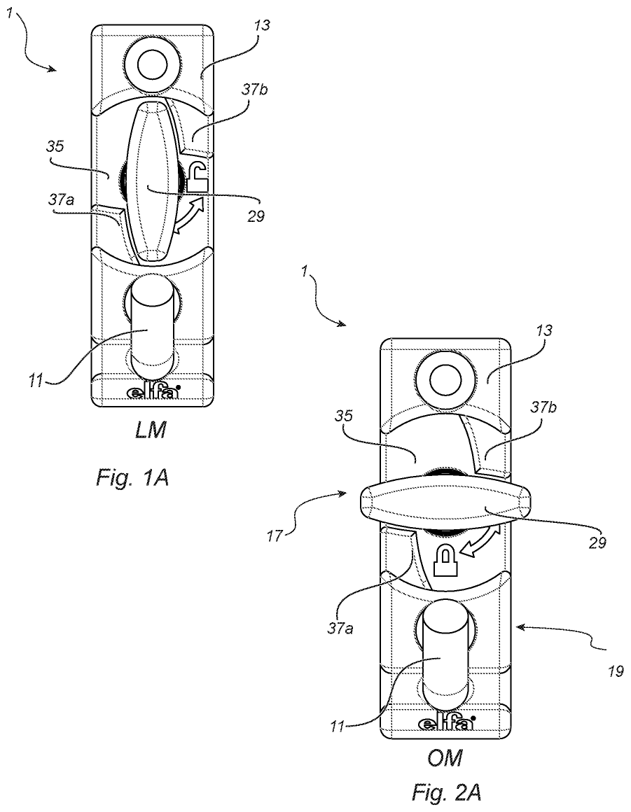

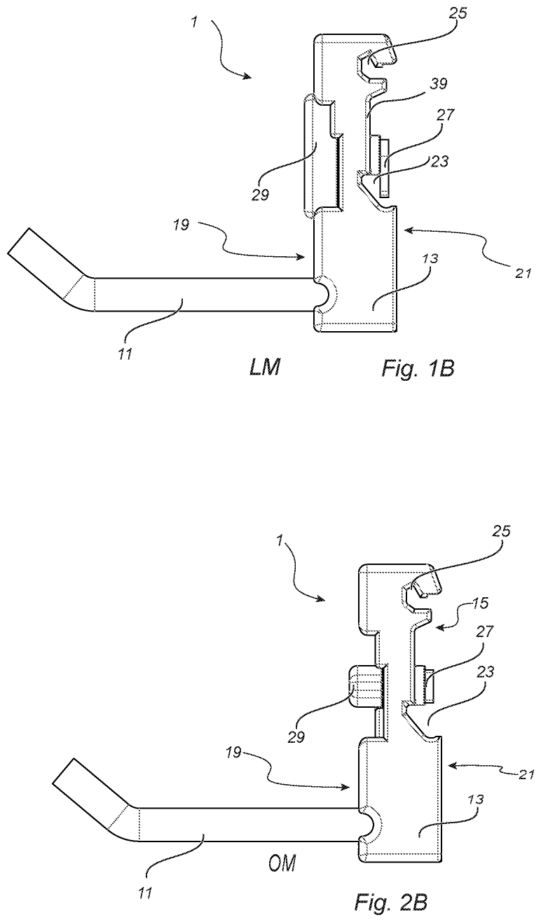

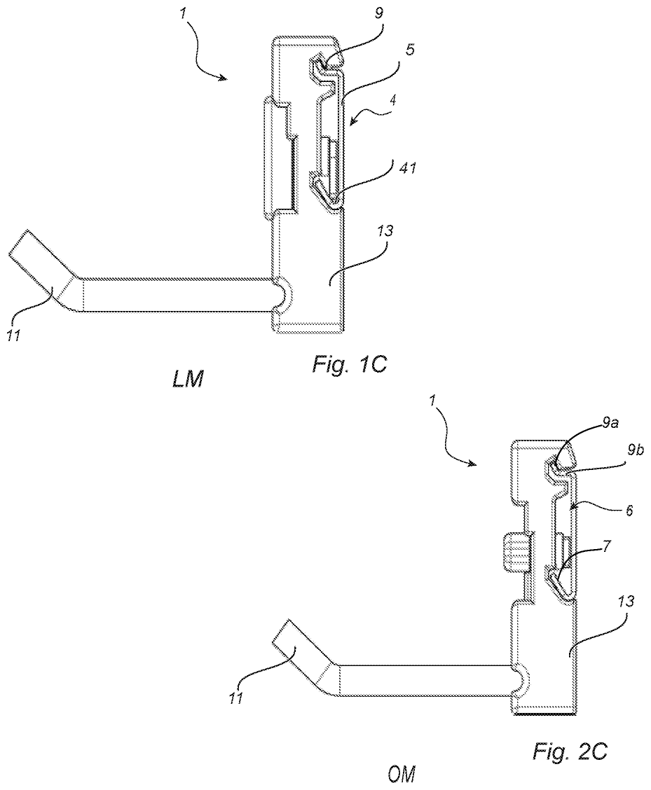

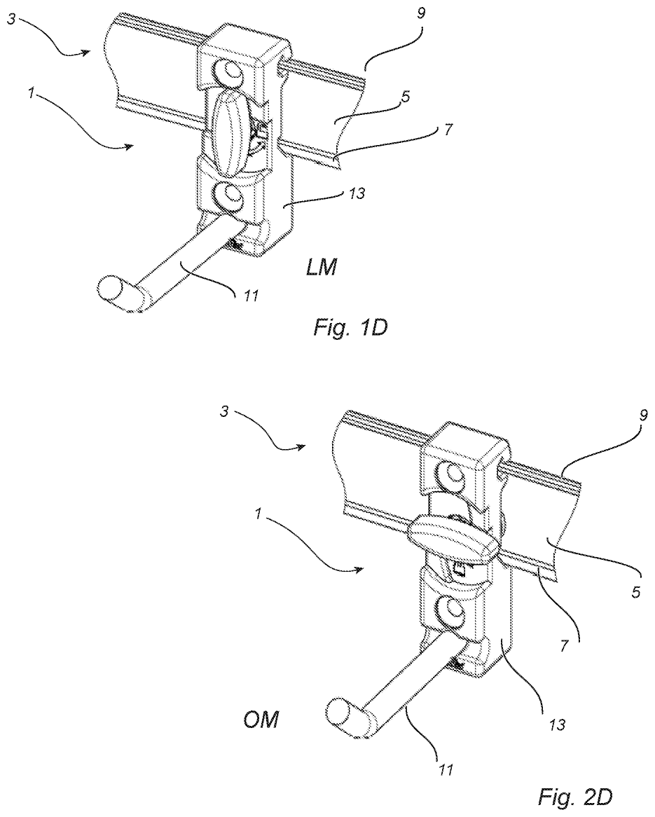

FIGS. 1A-1D and FIGS. 2A-2D illustrates an implement holder 1 according to a first embodiment of the disclosure in different views.

The implement holder 1 comprises a holding element 11 for suspending an implement, for example a tool, or a piece of garden or sport equipment, and a fastening device 13 for attachment of the implement holder 1 to a suspension bar 3 or on a wall.

As best seen in FIGS. 1D and 2D, the suspension bar 3 comprises an elongated rail 5 configured to be arranged horizontally on a vertical surface, such as a wall of a storage space, for example a garage or similar. The rail 5 may be made from a single strip of sheet metal and may comprise screw holes to allow the rail 5 to be fastened on the vertical surface. The screw holes may be elongated to allow some tolerance when making holes for screws in the vertical surface. As best seen in FIGS. 1C and 2C, the rail 5 may comprise a rear surface 4, which is configured to abut the vertical surface. The rear surface 4 may be flat, as shown, although it is not necessary. The rear surface generally extends in a vertical plane, which plane coincide with the vertical surface.

The rail 5 comprises a lower flange 7, which flange is bent out of the plane of the rear surface, more than 90 degrees, such that the lower edge of the strip making up the rail 5 is directed obliquely upwards. The upper edge of the strip making up the rail 5 is bent out of the plane of the rear surface 4 forming an upper flange 9 and being bent as well obliquely upwards. As shown in FIG. 2C, the upper flange 9 may have two differently angled portions 9A, 9B. At least partially, the upper 9 and the lower 7 flanges may extend in slightly different directions. Either flange should be configured to extend at least partially upwards when the rail is attached to a vertical surface to be able to suspend an implement holder.

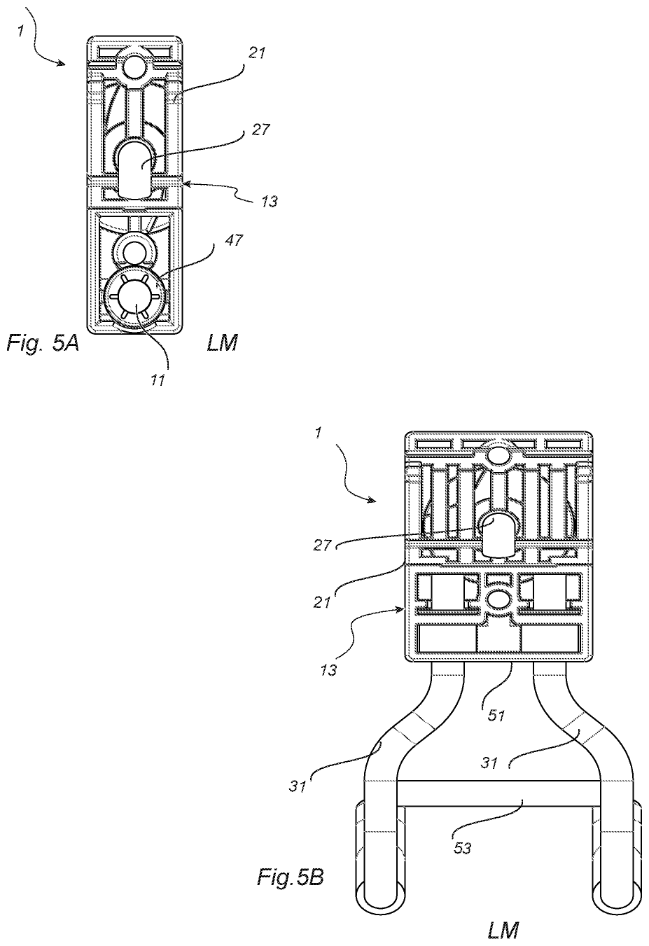

The main body of the fastening device 13 may be made of a plastic material that is injected moulded to form an elongated, rectangular part. The fastening device 13 comprises a rear face 19 and a front face 21. When the implement holder 1 is attached to the suspension bar 3, the fastening device 13 is arranged perpendicular to the suspension bar 3 with the rear face 19 facing the suspension bar 3. As indicated in FIGS. 5A, 5B the fastening device may have an uneven material thickness between the front face 19 and the rear face 21. The fastening device 13 is made up of a frame to ensure its strength and several cavities has been formed between the frame parts to save both manufacturing time and material.

The fastening device 13 further comprises an interface 15, arranged at the rear face 21, for retaining engagement with the profile of the suspension bar 3, and a locking device 17 to releasably secure the fastening device 13 to the suspension bar 3.

As indicated in FIGS. 1A, 2A, the interface 15 comprises a suspension slot 23, and a mounting slot 25, arranged in line with each other, perpendicular to the plane of the rear face 4 of the rail 5, with the mounting slot 23 at the top. The profiles of the suspension slot 23 and the mounting slot 25 complement or match the profiles of the upper 9 and lower 7 flanges. The profiles of the flanges 7, 9 allow for one of them or, optionally both to be inserted into the corresponding slots 23, 25 on the fastening device 13 from the front of the rail 5, but not at the same time. The bottom of the suspension slot 23 in the rail 5 may snap over a bottom bend 41 formed in the lower flange 7.

The configuration of the suspension slot 23 and the mounting slot 25 on one hand, and the lower flange 7 and the upper flange 9 of the other hand, match in such way that the implement holder 1 can be attached to and slide on the rail 5. At the same time, implement holder 1 becomes locked to the rail 5 in such way that it does not fall off the vertical surface and can reliably carry heavy objects.

The combination of slots 23, 25 and flanges 7, 9 also prevent that the implement holder 1 swings in the plane of the vertical surface, especially if the upper flange 9 has a portion 9b that projects more or less horizontally from plane of the rear surface 4 and the interface 15 has been adapted to support this portion 9b. As indicated in FIGS. 1B-1C and 2B-2Cc, the interface 15 may also be provided with a mounting recess 39. The mounting recess 39 is arranged between the mounting slot 25 and the suspension slot 23 and provides a connection between these slots. The latch element 27 is arranged at this mounting recess 39 proximate to the suspension slot 23, preferably above the suspension slot 23.

To further secure the fastening device 13 to the suspension bar 3 and prevent the fastening device 13 from turning around the suspension bar 3 when large and heavy objects are suspended in the holding element 11, which element 11 will be described below, a locking device 17 may be arranged on the fastening device 13.

The locking device 17 comprises a latch element 27 and a twist actuator 29, wherein the latch element 27 is rotatably attached to the twist actuator 29. The twist actuator 29 is arranged at the front face 19 of the fastening device 13, while the latch element 27 is arranged at the rear face 21 of the fastening device 13. In the embodiment shown, the twist actuator 29 has the shape of a knob, and the latch element 27 has the shape of a tab, but other embodiments are possible. The parts 27, 29 are connected to each other with an axis 28 extending through the fastening device 13. In the embodiment shown, the latch element 27 and the axis 28 are integrally formed.

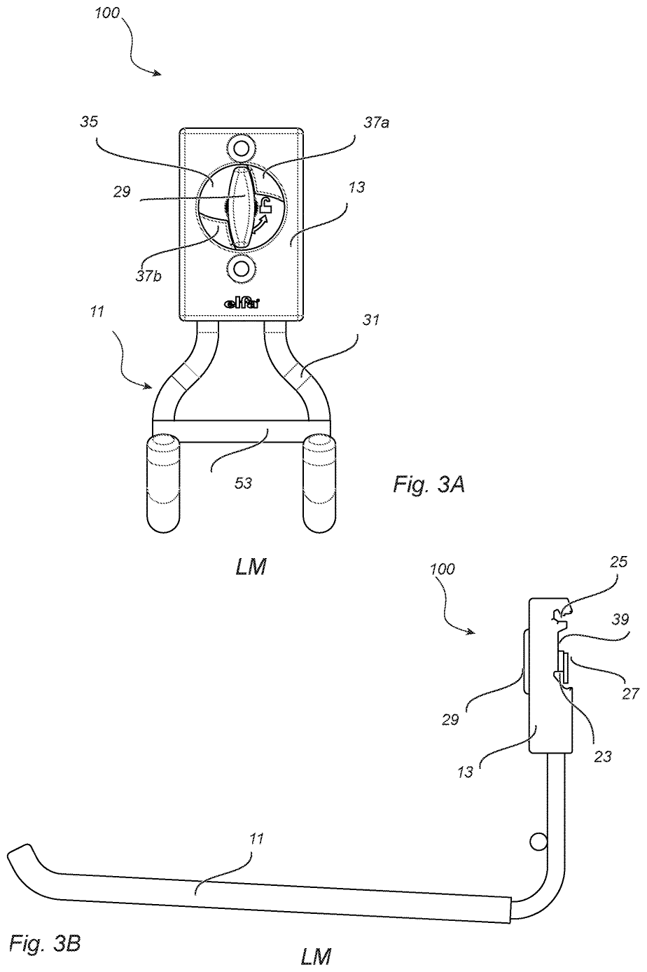

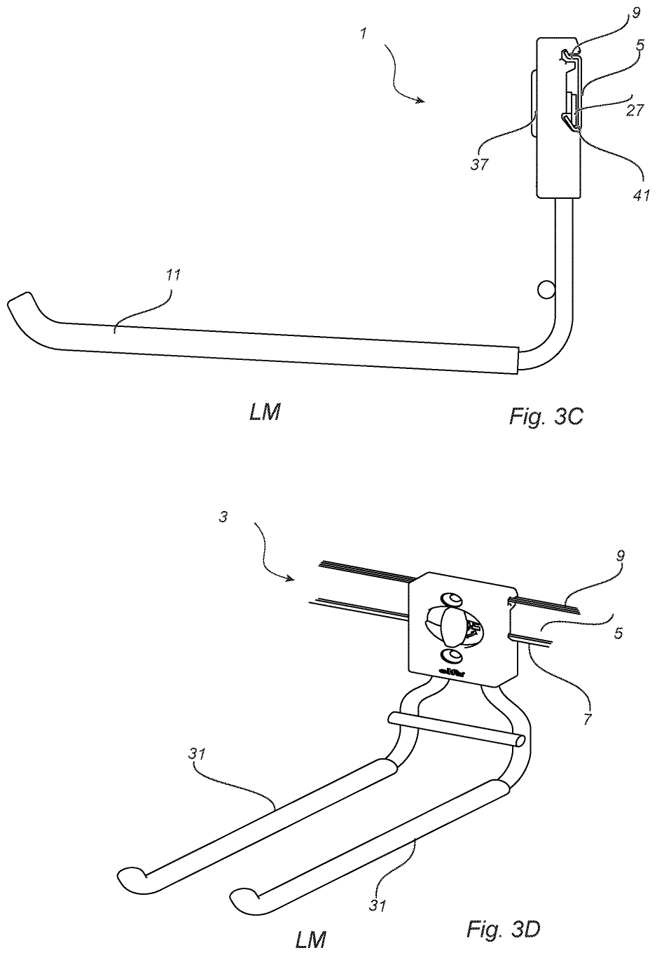

The twist actuator 29 is adapted to move between two predetermined positions to move the latch element 27 between a locked mode LM and an opened mode OM, shown in FIGS. 1A, 2A. The front face 19 of the fastening device 13 may be provided with a locking recess 35 and at least two stoppers 37 in form of tabs arranged at predetermined positions within the locking recess 35. The predetermined positions are preferably arranged 90 degrees apart. The twist actuator 29 is to be turned in this locking recess 35 between the stoppers 37 to move the latch element 27 between the opened mode OM and the locked mode LM. The stoppers 37a, 37b are adapted to prevent the twist actuator 29 from turning past the predetermined positions. When the latch element 27 is arranged in the locked mode LM, the twist actuator 29 is arranged at the first predetermined position, in the embodiment shown, an almost vertical position, perpendicular to the plane of the rear face 4 of the rail 5 and resting against the first stop 37a as indicated in FIGS. 1A-1D and 3A-3D. When the latch element 27 is arranged in the opened mode OM, the twist actuator 29 is arranged at the second predetermined position, in the embodiment shown, an almost horizontal position, along the plane of the rear face 4 of the rail 5 and resting against the second stop 37b, as indicated in FIGS. 2A-2D.

When the latch element 27 is in the opened mode OM, the latch element 27 is arranged in an almost vertical position, perpendicular to the plane of the rear face 4 of the rail 5, as indicated in FIGS. 2B and 2C. When the latch element 27 is arranged in the locking mode LM, the latch element 27 is arranged in an almost horizontal position, along the plane of the rear face 4 of the rail 5, as indicated in FIGS. 1B and 1C. FIG. 1C illustrates how the locking element 27 secures the fastening device 13 to the suspension bar 3 by abuting the bend 41 formed in the lower flange 7 of the suspension bar 3 when the implement holder 1 is suspended in the suspension bar 3

The implement holder 1 may also be provided with a holding element 11. The holding element 11 may have different shapes depending on which object(s) to be suspended in the element 11. In the first embodiment shown (FIGS. 1A-1D and 2A-2D), the holding element 11 has a hook-like appearance and consist of one leg 43.

The leg 43 is provided with a first end 43a, which is bent slightly upwards and extends from the front face 19 of the fastening device 13 and a second end 43b, opposite to the first end 43a along the extension direction of the leg 31, is attached to the fastening device 13. The second end 43b may be inserted in a through hole 45 arranged at a lower end 13b of the fastening device 13. Preferably below the fastening device 17 to avoid interference with the twist actuator 29. The second end 43b of the holding element 11 can be attached on the rear side 21 of the fastening device 13 by a lock washer 47 as shown in FIG. 5A. It could also be attached to the fastening device 13 in a press-fitting engagement.

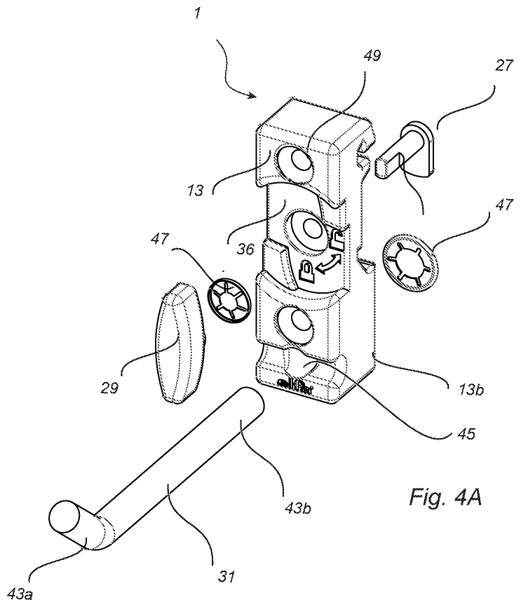

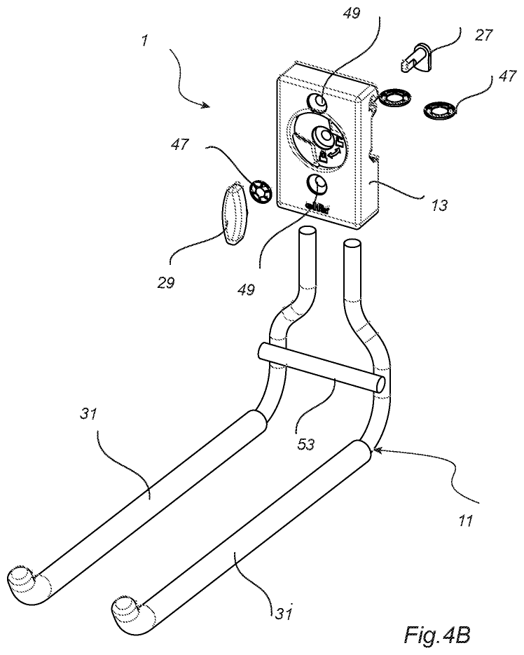

The twist actuator 29 and the latch element 27 may also be attached to each other by a lock washer 47 as indicated in FIG. 4A.

The fastening device 13 may also be provided with at least one fixing hole 49a, 49b for fixation of the implement holder 1 to a specific location on the suspension bar 3 or directly on a vertical surface, for example a wall. One fixation hole 49a may be arranged above the locking recess 35 and another fixation hole 49b may be arranged below the locking recess 35, in a straight line in longitudinal direction of the fastening device 13.

The implement holder 1 is attached to the suspension bar 3 by introducing the upper flange 9 of the suspension bar 3 into the mounting slot 25 of the interface 15 in the fastening device 13 and by introducing the lower flange 7 of the suspension bar 3 into the suspension slot 23 of the interface 15 in the fastening device 13 while the locking element 11is arranged in the opened mode OM. In this mode, there is a possibility to move the implement holder 1 slightly sideways along the extension direction of the suspension bar 3. To secure the implement holder 1 to the suspension bar 3, the latch element 27 is moved to the locking mode LM by turning the twist actuator 29 from the first predetermined position to the second predetermined position. If the implement holder 1 is to be moved on the suspension bar 3 or from the suspension bar 3, the process is reversed.

FIGS. 3A-3D, 4B and 5B illustrates a second embodiment of an implement holder 100 according to the invention. The differences between this embodiment and the first embodiment are that the holding element 11 is provided with two identical legs 31 instead of only one leg 31. The legs 31 are each arranged in a respective through hole 45 arranged in a bottom face 51 of the fastening device 13. The second end 43b of each leg 31 may be attached on the rear face 21 of the fastening device 13 by lock washers 47. They could also be attached to the fastening device 13 in a press-fitting manner. Each leg 31 has a hook-like appearance and has a first end 43a of which is bent slightly upwards and extends from the front face 19 of the fastening device 13. The legs 31arranged parallel with a certain distance from each other, and may be connected to each other by a cross bar 53 to make the holding element 11 more stable when an object(s) is suspended in the element 11. The main body of the fastening device 13 is wider to be able to house the two legs 31. Otherwise, the detailed description shall also be applied to this embodiment.

The invention has mainly been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality.

1. An implement holder adapted for attachment to a suspension bar, wherein the suspension bar comprises a rail comprising a rear surface configured to be arranged horizontally on a vertical surface, such as a wall or similar, a lower flange and an upper flange, each flange having portions that are directed obliquely upwards when the rail is attached to the vertical surface,
wherein the implement holder comprises a holding element for suspending an implement, such as a tool, a piece of garden or sport equipment or another object, and a fastening device which enables the holding element to be releasably attached to the suspension bar,
wherein the fastening device comprises an interface, comprising a suspension slot and a mounting slot for retaining engagement with the lower flange and the upper flange of the suspension bar, and a locking device comprising a latch element configured to be moved between a locked mode (LM) and an opened mode (OM), and
wherein the latch element is adapted to secure the lower flange of the suspension bar in the suspension slot when in locked mode (LM).

2. The implement holder according to claim 1, wherein the lower flange is bent out of a plane of the rear surface of the rail and the upper flange extends upwardly from the plane of the rear surface.

3. The implement holder according to claim 2, wherein the upper flange comprises an inner and an outer portion that are differently angled with respect to the plane of the rear surface.

4. The implement holder according to claim 1, wherein the latch element abuts against a bend in the lower flange when in locked mode (LM).

5. The implement holder according to claim 1, wherein the latch element abuts against a front face of the rail when in opened mode (OM).

6. The implement holder according claim 1, wherein the fastening device comprises a front face and a rear face, and wherein the rear face is facing the rail when the implement holder attached to the suspension bar.

7. The implement holder according to claim 1, wherein the latch element is rotatably attached to a twist actuator.

8. The implement holder according to claim 5, wherein the twist actuator is arranged on the front face of the fastening device configured to be moved between two predetermined positions, to move the locking element between a locked mode (LM) and an opened mode (OM).

9. The implement holder according to claim 8, wherein the predetermined positions are spaced 90° apart.

10. The implement holder according to claim 8, wherein the twist actuator can be turned in a range between stoppers arranged on the front face of the fastening device.

11. The implement according to claim 1, wherein the holding element is arranged at a lower end of the fastening device separate from the twist actuator.

12. The implement according to claim 1, wherein the holding element is provided with at least one leg, releasably connected to the fastening device by a clamping engagement.

13. The implement according to claim 1, wherein the holding element has a hook-like shape.

14. The implement according to claim 1, wherein the fastening device is provided with a least one fixation hole for fixation of the implement holder at the vertical surface.

15. The implement according to claim 2, wherein the latch element abuts against a bend in the lower flange when in locked mode (LM).

16. The implement according to claim 2, wherein the latch element abuts against a front face of the rail when in opened mode (OM).

17. The implement according to claim 2, wherein the fastening device comprises a front face and a rear face, and wherein the rear face is facing the rail when the implement holder is attached to the suspension bar.

18. The implement holder according to claim 2 wherein the latch element is rotatably attached to a twist actuator.

19. The implement holder according to claim 8, wherein the twist actuator can be turned in a range between stoppers arranged on the front face of the fastening device.
